(19) United States
(12) Patent Application Publication
(10) Pub. No.: US 2024/0411905 A1
(43) Pub. Date: Dec. 12, 2024

(54) ACCESS PRIVILEGE REMOVAL BASED ON EFFICIENT ACCESS PRIVILEGE USAGE MONITORING FOR DATA ENVIRONMENTS

(71) Applicant: Veza Technologies, Inc., Los Gatos, CA (US)

(72) Inventors: Maohua Lu, Fremont, CA (US); Tarun Thakur, Los Gatos, CA (US); Robert Whitcher, Erie, CO (US)

(21) Appl. No.: 18/736,116

(22) Filed: Jun. 6, 2024

Related U.S. Application Data
(60) Provisional application No. 63/506,495, filed on Jun. 6, 2023.

(51) Int. Cl. G06F 21/60

(52) U.S. Cl. CPC G06F 21/604; G06F 2221/2101; G06F 2221/2135; G06F 2221/2141

(57) ABSTRACT

The technology disclosed herein enables removal of unused access privileges for data environments based on usage. In a particular example, a method provides accessing audit logs for a plurality of data environments. The audit logs indicate which permissions were used for the plurality of data environments during and corresponding times in which the permissions were used. The method also provides aggregating the permissions into timeframes based on the corresponding times and tracking, in a database, a number of times each of the permissions was used in each of the timeframes. In response a one of the permissions satisfying a usage threshold, the method provides removing the one of the permissions.

### RELATED APPLICATIONS

This application is related to and claims priority to U.S. Provisional Patent Application 63/506,495, titled “ACCESS PRIVILEGE REMOVAL BASED ON EFFICIENT ACCESS PRIVILEGE USAGE MONITORING FOR DATA ENVIRONMENTS,” filed Jun. 6, 2023, and which is hereby incorporated by reference in its entirety.

### TECHNICAL BACKGROUND

Modern enterprises use numerous data environments to store, manage, and/or process data and those environments may be managed by different systems, applications, and/or platforms from different providers and each may use its own data repository (e.g., database). For instance, different departments may employ different database systems depending on the features offered by the respective system (e.g., accounting may use a first database system while human resources uses a second). In some cases, a single department may itself use multiple platforms for data repositories depending on the capabilities of each platform even if the platforms manage similar data sets. For example, human resources may use one platform to onboard and terminate employees from the enterprise while another platform is used to handle employees' compensation and benefits. Given the large number of users and resources of the data environments to which the users may have access, the number of access privileges for the data environments given to those users may also be large and hard to track.

### SUMMARY

The technology disclosed herein enables removal of unused access privileges for data environments based on usage. In a particular example, a method provides accessing audit logs for a plurality of data environments. The audit logs indicate which permissions were used for the plurality of data environments during and corresponding times in which the permissions were used. The method also provides aggregating the permissions into timeframes based on the corresponding times and tracking, in a database, a number of times each of the permissions was used in each of the timeframes. In response a one of the permissions satisfying a usage threshold, the method provides removing the one of the permissions.

In another example, an apparatus is provided having one or more computer readable storage media and a processing system operatively coupled with the one or more computer readable storage media. Program instructions stored on the one or more computer readable storage media, when read and executed by the processing system, direct the apparatus to perform the steps of the above-recited method.

### BRIEF DESCRIPTION OF THE DRAWINGS

FIG. 1 illustrates an implementation for removing unused access privileges for data environments.

FIG. 2 illustrates an operation to remove unused access privileges for data environments.

FIG. 3 illustrates an operation to remove unused access privileges for data environments.

FIG. 4 illustrates an operation to remove unused access privileges for data environments.

FIG. 5 illustrates a timeline for removing unused access privileges for data environments.

FIG. 6 illustrates an operation to remove unused access privileges for data environments.

FIG. 7 illustrates a computing architecture for removing unused access privileges for data environments.

### DETAILED DESCRIPTION

The activity monitoring systems disclosed below identifies access permissions that are used over a period of time to provide a better picture of which access permissions are actually being used by users with privileges to access resources provided by data environments. Especially in configurations where a large number of access permissions exist, recognizing which of the access permissions are actually being used may be next to impossible for a human user. Recognizing that an access permission is not being used may allow for removal of that access permission. Removal of the access privilege not only declutters the access privileges for the data environments but also increases security for the data environments. The more access privileges a configuration has the more chances that a resource of the data environments may be accessed by a user who should not have access. Thus, removing access privileges that are not used reduces the chances that an access privilege is improperly used.

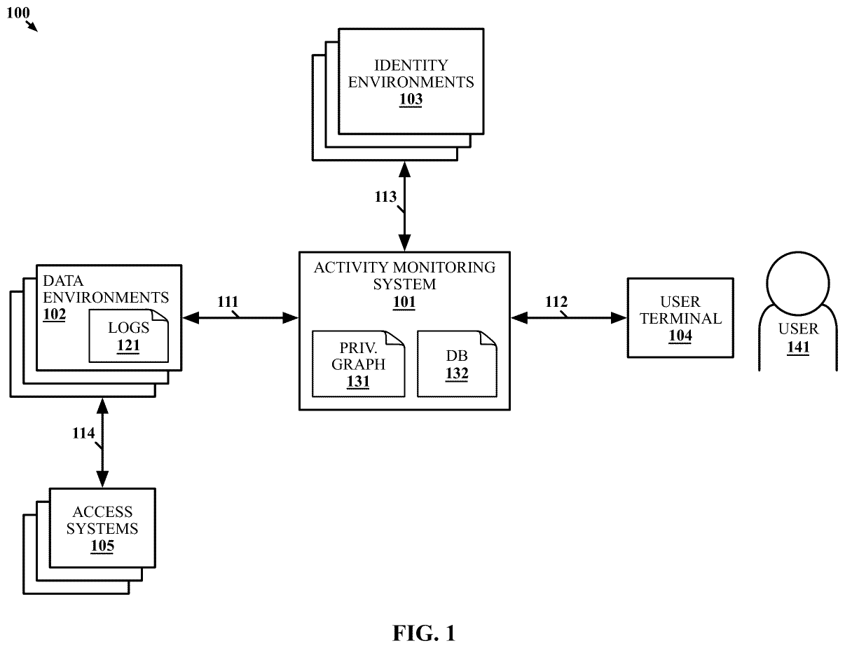

FIG. 1 illustrates implementation 100 for automating access review for access decisions responsive to access requests to data environments. Implementation 100 includes activity monitoring system 101, data environments 102, identity environments 103, user terminal 104, and access systems 105. Activity monitoring system 101 and data environments 102 communicate over respective communication links 111. Activity monitoring system 101 and user terminal 104 communicate over communication link 112. Activity monitoring system 101 and access systems 105 communicate over communication links 114. Activity monitoring system 101 and identity environments 103 communicate over respective communication links 113. While communication links 111-114 are shown as direct links, communication links 111-113 may include intervening systems, networks, and/or devices. Activity monitoring system 101 executes on one or more computing systems, such as server systems, having processing and communication circuitry to operate as described below. User terminal 104 is a user operated computing system, such as a desktop workstation, laptop, tablet computer, smartphone, etc. Access systems 105 may include user operated computing systems, unmanned servers, or any other type of computing system that may access resources provided by data environments 102 including combinations thereof. Similarly, while human users are described herein as accessing the resources (i.e., via their respective user systems) in the examples herein, users accessing data environments 102 may include non-human users, such as systems, applications, micro-services, etc., or some combination thereof.

In operation, activity monitoring system 101 is a computing system that performs operation 200 to identify access privileges that are not being used to access data environments 102 and remove those access privileges. Data environments 102 include one or more systems that host databases, such as databases for Online Transaction Processing (OLTP) and Online Analytical Processing (OLAP), tables, files, applications, or other computing resources provided to access systems 105 including combinations thereof. Identity environments 103 include one or more systems that maintain information about users (e.g., user identity information, user attributes, etc.) and information about which of data environments 102 (including specific data/features therein) each user is allowed to access. Identity environments 103 may include an active directory (AD) server, an Okta® system, an Identity and Access Management (IAM) system, a privilege access management (PAM) system, human resources management system (HRMS), identity and access governance (IAG) system, or any other type of system that maintains the user information discussed above. Identity environments 103 maintain identity information about users that may access one or more of data environments 102. The identity information may include authorization information indicating whether given users are allowed to access particular resources provided by data environments 102 or ones of data environments 102 as a whole. In some examples, a data environment of data environments 102 may authorize a user itself based on identity information for the user included in identity environments 103. For instance, identity environments 103 may indicate information about a user, such as a work group for the user, the user's job title/role, a seniority of the user, a security clearance level for the user, or any other type of information that may affect which of data environments 102 the user can access. In further examples, a data environment of data environments 102 may authorize users independently.

In general, activity monitoring system 101 determines which access privileges are used and how often the access privileges are used to determine whether an access privilege is used infrequently enough for removal. Activity monitoring system 101 may also maintain the access-privilege usage information to respond to queries received about the usage information. For example, a query may request activity monitoring system 101 to provide all resources of data environments 102 that were accessed by a certain user in a given timeframe (e.g., within the last week). Activity monitoring system 101 can lookup the access permissions used by the user and determine which resources the user accessed. Moreover, activity monitoring system 101 can provide the number of times each access permission was used by the user in the specified timeframe.

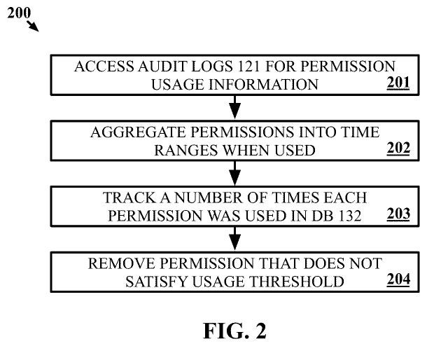

FIG. 2 illustrates operation 200 to remove unused access privileges for data environments. In operation 200, activity monitoring system 101 accesses audit logs 121 for data environments 102 (201). Each of audit logs 121 is maintained by a respective one of data environments 102. Audit logs 121 indicate which permissions were used for the plurality of data environments during and corresponding times in which the permissions were used. For example, one entry of audit logs 121 may indicate that a user A, via one of access systems 105, used a privilege that allowed user A to access a resource B in one of data environments 102 at a specific time. Other entries may indicate other instances when the same privilege was used by user A. Activity monitoring system 101 may access audit logs 121 in response to a query, at periodic time intervals, or on some other schedule.

Activity monitoring system 101 aggregates the permissions used into timeframes based on the corresponding times (202). The timeframes need not all be equal in length. For example, for the past day, the timeframes may each comprise five minutes. For a day before that, the timeframes may be hourly and, for days/weeks/etc. further back in time, the timeframes may get less granular (e.g., bi-hourly, daily, etc.), as it is less likely that information compiled using shorter timeframes would be beneficial for older instances of permission usage. As the information in a given timeframe itself ages (e.g., today becomes yesterday), activity monitoring system 101 may aggregate the information in multiple timeframes into a single new timeframe (e.g., 12 five-minute timeframes into a single one-hour timeframe).

Activity monitoring system 101 tracks, in database 132, a number of times each of the permissions was used in each of the timeframes (203). Using the above-identified timeframes, activity monitoring system 101 at least keeps a count within each timeframe for each permission used in the timeframe. For example, if the example permission involving user A and resource B above was used three times in a particular timeframe, then activity monitoring system 101 stores a count of three in association with the permission within database 132. Counts for other permissions used during the timeframe are similarly stored within database 132. Database 132 may be a non-graph time-series-optimized database, which is a type of database system designed to efficiently store, retrieve, and analyze time-series data. Unlike graph databases, which are optimized for storing and querying graph-structured data, a time-series-optimized database is tailored to handle data points indexed by time stamps (e.g., times in which a permission is used).

In response a one of the permissions satisfying a usage threshold during one of the timeframes, activity monitoring system 101 removes the one of the permissions (204). The usage threshold may be set to any number desired by an administrator of data environments 102 (e.g., user 141). The usage threshold may be satisfied when a permission is not used at all within a period of time (e.g., the timeframes for the last month) or may be satisfied by some non-zero number of uses (e.g., only used four times in the last month). There may be multiple usage thresholds corresponding to different periods of time (e.g., a threshold for a month-long period may be zero usages while a threshold for a six-month period may be five uses) or different types of permissions (e.g., a threshold for financial resources in data environments 102 may be three uses while a threshold for HR resources in data environments 102 may be zero uses). Activity monitoring system 101 may remove a privilege automatically or may present the privilege to user 141 for review and then remove the privilege only when user 141 instructs activity monitoring system 101 to do so.

In some examples, activity monitoring system 101 may reference privilege graph 131 to remove the threshold-satisfying privilege. Privilege graph 131 is a graph that connects nodes representing users to resources of data environments 102. Intervening attribute nodes of privilege graph 131 between the users and the resources indicate attributes of the users connected to the attribute nodes. Privilege graph 131, therefore, indicates which users should have access to which resources of data environments 102. When activity monitoring system 101 determines a privilege should be removed, activity monitoring system 101 may reference privilege graph 131 to determine how that privilege fits into the other privileges available for data environments 102. Activity monitoring system 101 can then create, delete, or modify rules used by data environments 102 and/or identity environments 103 to implement the privileges to ensure other privileges are not affected when the identified privilege is removed.

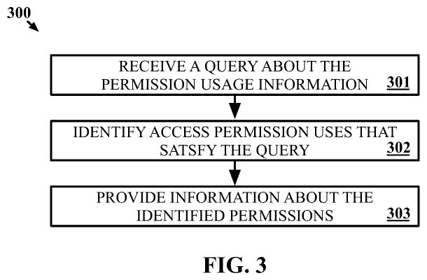

FIG. 3 illustrates operation 300 to remove unused access privileges for data environments. Operation 300 is an operation that may be performed by activity monitoring system 101 based on information stored in database 132 regarding privilege usage during different timeframes. In operation 300, activity monitoring system 101 receives a query about privilege usage with respect to data environments 102 (301). The query may be received from user 141 via user terminal 104. The query may be any query that can be answered using the data stored in database 132. For instance, the query may ask which users accessed a particular resource during a period of time or ask which resources were accessed by a particular user (and how many times they were accessed).

Activity monitoring system 101 identifies access permission uses in database 132 that satisfy the query (302). If a query identifies a particular user and/or resource, then activity monitoring system 101 identifies entries in database 132 that involve privileges involving the user or resource. For example, if the query asks which users accessed a resource during a period of time, activity monitoring system 101 identifies the timeframes within the period of time and identifies the permissions involving the resource within those timeframes. Activity monitoring system 101 then provides information about the identified permissions to user 141 in response to the query (303). Continuing the above example, if activity monitoring system 101 finds ten different users used access privileges to access the resource, then activity monitoring system 101 identifies the ten users in a response to the query.

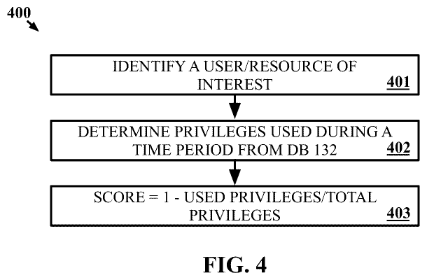

FIG. 4 illustrates operation 400 to remove unused access privileges for data environments. Operation 400 describes a score that activity monitoring system 101 may use as a metric for indicating relative use of privileges (i.e., indicating whether privileges for users/resources are used a lot or a little). Activity monitoring system 101 identifies a user or resource of interest (401). The score may be user-centric or resource-centric. Activity monitoring system 101 may identify a user/resource on its own to pre-calculate scores and cache them for future reference or activity monitoring system 101 may wait until a particular user or resource is identified by a query before calculating the score in response to the query. Activity monitoring system 101 then identifies all privileges used by the user/resource during a time period (402). The time period may also be identified by a query identifying the user/resource or activity monitoring system 101 may use a default time period.

Activity monitoring system 101 calculates the score as being one minus the quotient of the number of privileges used for the user/resource divided by a total number of privileges in data environments 102 (403). Higher scores indicate a user/resource is more over-privileged (i.e., is associated with too few used privileges relative to the total number of privileges). A score threshold may indicate when user 141 should be notified about an over-privileged user/resource. For example, activity monitoring system 101 may determine that any score over 0.9 should trigger a notification to user 141 regarding the user/resource having the high score. User 141 may then take action to reduce the score. Alternatively, activity monitoring system 101 may identify privileges that have not been used in a while (e.g., within a threshold amount of time) and automatically remove those privileges to improve the score. In some examples, the total number of privileges may be the total number of privileges assigned to the user/resource. In those examples, the score may have greater variation when removing privileges assigned to the user/resource but not used for the user/resource. Ideally, only privileges that are actually used will be assigned to help prevent a bad actor from using privileges.

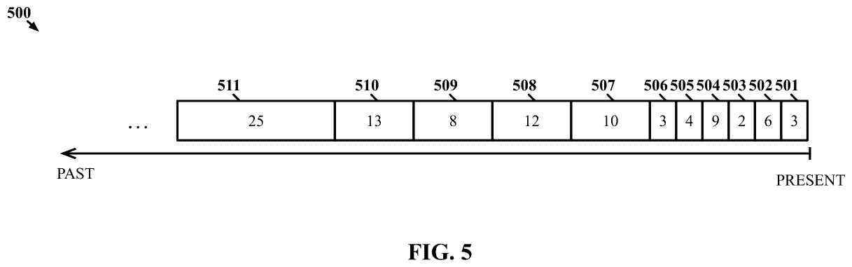

FIG. 5 illustrates timeline 500 for removing unused access privileges for data environments. Timeline 500 is a visualization of how statistics for privilege usage may be represented in database 132. Timeline 500 shows the present time at the far right and time goes farther into the past moving to the left on timeline 500 from the present time. Timeframes 501-511 are shown on timeline 500. The width of timeframes 501-511 represents a length of each of timeframes 501-511 relative to one another. Those of timeframes 501-511 closer to the present time are shorter timeframes than those further away. Timeframes 501-506 are all include the same amount of time which is the shortest amount of time relative to the other timeframes that cover times further in the past. Timeframes closer to the present time are shorter to provide more granularity for more recent privilege use events. Timeframes 507-510 are four timeframes that include the same amount of time and are longer than timeframes 501-506. Specifically, the width of one of timeframes 507-510 is three times that of timeframes 501-506 indicating one of timeframes 507-510 represents three times the amount of time represented by one of timeframes 501-506. Timeframe 511 is wider still because timeframe 511 represents twice as much time as one of timeframes 507-510. Additional timeframes may be represented further left on timeline 500 from what is shown. Those additional timeframes may represent the same amount of time as timeframe 511 or may represent one or more greater amounts of time.

In this example, the numbers within a timeframe indicate how many times a privilege was used during each respective one of timeframes 501-511. For instance, timeframe 504 saw nine instances in which the privilege was used and timeframe 509 included eight instances in which the privilege was used. As time passes, activity monitoring system 101 may aggregate shorter timeframes into longer time frames. For example, when timeframes 504-506 are older than a threshold, timeframes 504-506 may be aggregated into a single timeframe the same length as timeframes 507-510. The number of privilege uses indicated by that new timeframe would be sixteen, which is the sum of the usage numbers in timeframes 504-507. Similarly, when timeframes 509-510 are older than another threshold, timeframes 509-510 may be aggregated into a single timeframe the same length as timeframe 511. The usage number in that case would be 21. Other information stored in database 132 about the privilege usage during the timeframes may also be aggregated into the new timeframes.

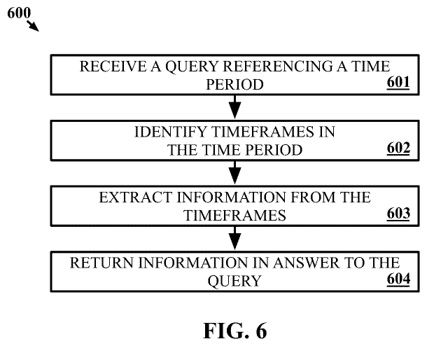

FIG. 6 illustrates operation 600 to remove unused access privileges for data environments. The aggregated information activity monitoring system 101 stores in database 132 may be used to respond to queries, such as a query from user 141. In operation 600, activity monitoring system 101 receives a query from user 141 via user terminal 104 that references a time period (step 601). The query may be any type of query that can be answered with information gathered by activity monitoring system 101 and stored in database 132. For example, the types of queries may include 1) return all users/resources having a score condition (i.e., >, <, =) satisfying a score threshold over a time range, 2) return users having accessed a certain resource over a period of time, 3) return all resources which have been accessed by a certain user over a period of time, 4) return all users/resources where a certain abstract permission has been exercised over a time range, and 5) return all users/resources where a certain raw permission (e.g., in some examples a privilege may be implemented using multiple permissions and this query pertains to a particular, or raw, permission) has been exercised over a time range.

In response to the query, activity monitoring system 101 identifies timeframes corresponding to the time period (step 602). The time period may lineup exactly with one or more timeframes stored within database 132 or may need to be modified to fit one or more timeframes. For example, the time period may align with timeframes 504-507. The alignment may be coincidental or user 141 may select the time period from the available timeframes. If the time period does not align with one or more timeframes, activity monitoring system 101 may determine a best fit between the time period and one or more of the timeframes. In those cases, activity monitoring system 101 may estimate what the answer to the query would be had there been alignment (e.g., may reduce a value in a timeframe by 25% if the time period only covers 75% of the timeframe) or may return an answer covering the timeframes determined by the best fit and notify user 141 about the different time period used for the answer.

Activity monitoring system 101 extracts information required to answer the query from the identified timeframes (step 603). For instance, when the query relies on scores, activity monitoring system 101 may calculate scores from information in database 132 corresponding to the identified timeframes (e.g., in accordance with operation 400). Activity monitoring system 101 may also identify users using a permission during the timeframes, resources accessed using a permission during the timeframes, or extract some other information included in database 132 for the identified timeframes. After extracting the information, activity monitoring system 101 returns an answer to the query (e.g., presents the answer to user 141) (step 604). The extracted information itself may be the answer to some queries or activity monitoring system 101 may need to transform or otherwise process the extracted information to generate the answer. For example, extracted permission usage information may be processed to calculate scores for users to identify which users should be returned as an answer to the query.

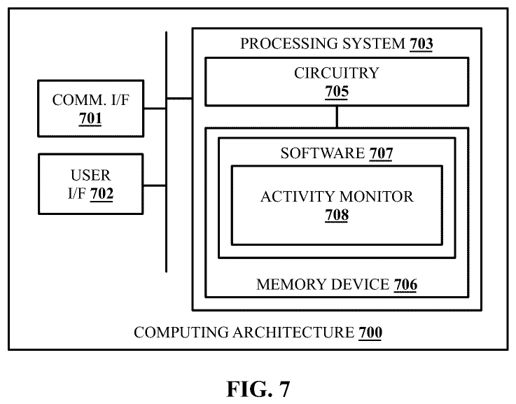

FIG. 7 illustrates computing architecture 700 for removing unused access privileges for data environments. Computing architecture 700 is an example computing architecture for activity monitoring system 101, although activity monitoring system 101 may use alternative configurations. A similar architecture may also be used for other systems described herein (e.g., data environments 102, identity environments 103, user terminal 104, and access systems 105), although alternative configurations for those systems may also be used. Computing architecture 700 comprises communication interface 701, user interface 702, and processing system 703. Processing system 703 is linked to communication interface 701 and user interface 702. Processing system 703 includes processing circuitry 705 and memory device 706 that stores operating software 707.

Communication interface 701 comprises components that communicate over communication links, such as network cards, ports, RF transceivers, processing circuitry and software, or some other communication devices. Communication interface 701 may be configured to communicate over metallic, wireless, or optical links. Communication interface 701 may be configured to use TDM, IP, Ethernet, optical networking, wireless protocols, communication signaling, or some other communication format including combinations thereof.

User interface 702 comprises components that interact with a user. User interface 702 may include a keyboard, display screen, mouse, touch pad, or some other user input/output apparatus. User interface 702 may be omitted in some examples.

Processing circuitry 705 comprises microprocessor and other circuitry that retrieves and executes operating software 707 from memory device 706. Memory device 706 comprises a computer readable storage medium, such as a disk drive, flash drive, data storage circuitry, or some other memory apparatus. In no examples would a computer readable storage medium of memory device 706, or any other computer readable storage medium herein, be considered a transitory form of signal transmission (often referred to as “signals per se”), such as a propagating electrical or electromagnetic signal or carrier wave. Operating software 707 comprises computer programs, firmware, or some other form of machine-readable processing instructions. Operating software 707 includes activity monitor 708. Operating software 707 may further include an operating system, utilities, drivers, network interfaces, applications, or some other type of software. When executed by processing circuitry 705, operating software 707 directs processing system 703 to operate computing architecture 700 as described herein.

In particular example, activity monitor 708 directs processing system 703 to access audit logs for a plurality of data environments. The audit logs indicate which permissions were used for the plurality of data environments during and corresponding times in which the permissions were used. Activity monitor 708 directs processing system 703 to aggregate the permissions into timeframes based on the corresponding times and track, in a database, a number of times each of the permissions was used in each of the timeframes. In response a one of the permissions satisfying a usage threshold, activity monitor 708 directs processing system 703 to remove the one of the permissions.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

What is claimed is:

1. A method comprising:
accessing audit logs for a plurality of data environments, wherein the audit logs indicate which permissions were used for the plurality of data environments during and corresponding times in which the permissions were used;
aggregating the permissions into timeframes based on the corresponding times;
tracking, in a database, a number of times each of the permissions was used in each of the timeframes; and
in response to a permission of the permissions satisfying a usage threshold during one or more of the timeframes, removing the permission.

2. The method of claim 1, wherein the timeframes are shorter nearer to a present time and longer farther from the present time.

3. The method of claim 2, wherein the usage threshold is greater for timeframes farther from the present time and lower for timeframes nearer to the present time.

4. The method of claim 1, wherein the usage threshold is one of multiple usage thresholds corresponding to different timeframes that are satisfied, and wherein removing the permission comprise:
removing the permission in response to the multiple usage thresholds being satisfied.

5. The method of claim 1, comprising:
receiving a query about permission usage for the plurality of data environments, wherein the query identifies one or more of the timeframes for search;
determining an answer to the query from a subset of the permissions in the one or more timeframes; and
returning the answer.

6. The method of claim 1, comprising:
identifying a user or resource of interest;
determining one or more used permissions of the permissions that are used with respect to the user or resource during a time period; and
generating a score based on the one or more used permissions, wherein the score indicates a relative risk of permissions associated with the user or resource.

7. The method of claim 6, wherein generating the score comprises:
dividing an amount of the one or more used permissions by an amount of total permissions in the plurality of permissions and then subtracting from one to calculate the score, wherein higher scores indicate the user or resource is more over-privileged relative to lower scores.

8. The method of claim 6, comprising:
notifying a user when the score indicates a relative risk greater than a threshold.

9. The method of claim 1, comprising:
enforcing the permissions on access requests to the plurality of data environments after the permission is removed.

10. The method of claim 1, wherein the database is a non-graph time-series-optimized database.

11. An apparatus comprising:
one or more computer readable storage media;
a processing system operatively coupled with the one or more computer readable storage media; and
program instructions stored on the one or more computer readable storage media that, when read and executed by the processing system, direct the apparatus to:
access audit logs for a plurality of data environments, wherein the audit logs indicate which permissions were used for the plurality of data environments during and corresponding times in which the permissions were used;
aggregate the permissions into timeframes based on the corresponding times;
track, in a database, a number of times each of the permissions was used in each of the timeframes; and
in response to a permission of the permissions satisfying a usage threshold during one or more of the timeframes, remove the permission.

12. The apparatus of claim 11, wherein the timeframes are shorter nearer to a present time and longer farther from the present time.

13. The apparatus of claim 12, wherein the usage threshold is greater for timeframes farther from the present time and lower for timeframes nearer to the present time.

14. The apparatus of claim 11, wherein the usage threshold is one of multiple usage thresholds corresponding to different timeframes that are satisfied, and wherein to remove the permission, the program instructions direct the processing system to:
remove the permission in response to the multiple usage thresholds being satisfied.

15. The apparatus of claim 11, wherein the program instructions direct the processing system to:
receive a query about permission usage for the plurality of data environments, wherein the query identifies one or more of the timeframes for search;
determine an answer to the query from a subset of the permissions in the one or more timeframes; and
return the answer.

16. The apparatus of claim 11, wherein the program instructions direct the processing system to:
identify a user or resource of interest;
determine one or more used permissions of the permissions that are used with respect to the user or resource during a time period; and
generate a score based on the one or more used permissions, wherein the score indicates a relative risk of permissions associated with the user or resource.

17. The apparatus of claim 16, wherein to generate the score, the program instructions direct the processing system to:
divide an amount of the one or more used permissions by an amount of total permissions in the plurality of permissions and then subtracting from one to calculate the score, wherein higher scores indicate the user or resource is more over-privileged relative to lower scores.

18. The apparatus of claim 16, wherein the program instructions direct the processing system to:
notify a user when the score indicates a relative risk greater than a threshold.

19. The apparatus of claim 11, wherein the program instructions direct the processing system to:
enforce the permissions on access requests to the plurality of data environments after the permission is removed.

20. A method comprising:
accessing audit logs for a plurality of data environments, wherein the audit logs indicate which permissions were used for the plurality of data environments during and corresponding times in which the permissions were used;
aggregating the permissions into timeframes based on the corresponding times;
tracking, in a database, a number of times each of the permissions was used in each of the timeframes;
receiving a query about permission usage for the plurality of data environments, wherein the query identifies a time period for a search;
identifying one or more of the timeframes corresponding to the time period;
determining an answer to the query from a subset of the permissions in the one or more timeframes; and
returning the answer.
